(19) United States
(12) Patent Application Publication
(10) Pub. No.: US 2012/0324825 A1
(43) Pub. Date: Dec. 27, 2012

(54) ANCHOR BOLT TEMPLATE

(76) Inventor: Peter A. Vrame, Barrington Hills, IL (US)

(21) Appl. No.: 13/165,402

(22) Filed: Jun. 21, 2011

(51) Int. Cl. E04B 1/38; G01B 3/14

(52) U.S. Cl. 52/745.21; 33/562

(57) ABSTRACT

A reusable anchor bolt template facilitates positioning of anchor bolts in anchoring material such as concrete, for subsequent mounting of a vertical structure, such as a light pole or the like. The anchor bolt template comprises a template body which defines a plurality of bolt-receiving channels within which the anchor bolts are respectfully positioned. By this arrangement, the template and anchor bolt can be positioned, as an assembly or unit, on an associated cylindrical tube or like structure which contains and confines the associated anchoring material. The template can be configured to permit the introduction of the anchoring material generally to the template, with the template thereafter being removable, and reused, if desired.

### TECHNICAL FIELD

The present invention relates generally to an arrangement to facilitate installation of a vertical structure, such as a light pole or post, and more particularly to a reusable anchor bolt template configured to receive a plurality of associated anchor bolts, and facilitate simultaneous positioning of the template and the anchor bolts, as an assembly, for subsequent introduction of anchoring material, such as concrete or the like.

### BACKGROUND ART

Installation of vertical structures, such as light poles or posts, ordinarily entails the provision of a suitable anchoring structure, such as a mass of concrete or like material. To facilitate secure mounting of the vertical structure, a plurality of suitable anchor bolts, or like mechanical fasteners, are typically embedded in the anchoring material. The vertical structure can then be secured to the anchor bolts, whereby the structure is securely and stably mounted in the desired vertical orientation.

Heretofore, anchor bolts such as described above have been individually positioned in association with anchoring material such as concrete, such as by inserting each of the anchor bolts into the concrete before it hardens. Positioning of the anchor bolts in this matter can be time consuming, since the anchor bolts must be accurately positioned for securely anchoring the associated vertical structure. As will be appreciated, repositioning of the anchor bolts cannot be easily affected after the concrete hardens, thus mandating precise positioning of the anchor bolts.

The present invention contemplates an arrangement whereby a plurality of anchor bolts can be efficiently and accurately positioned in operative association with anchoring material such as concrete, whereby installation of a vertical structure such as a light pole or the like, or other anchored structure, is greatly facilitated.

### SUMMARY OF THE INVENTION

In accordance with the present invention, a reusable anchor bolt template is provided which facilitates simultaneous positioning of a plurality of anchor bolts, as an assembly with the template, in operative association with anchoring material such as concrete or the like. The anchor bolt template is configured for use with an associated cylindrical tube, sometimes referred to a sonotube, within which the anchoring material is confined and contained to form the desired anchoring structure for an associated vertical structure, such as a light pole or the like. By simultaneous, precise positioning of the anchor bolts, efficient installation and anchoring of the associated vertical structure is greatly facilitated.

In accordance with the illustrated embodiment, the present anchor bolt template includes a template body having a generally planar configuration, defining upper and lower surfaces. The template body defines a plurality of circumferentially spaced channels extending radially inwardly of the periphery of the template body. Each of the channels has generally parallel side edges, with the channels preferably being of substantially equal length. In the illustrated embodiments, the channels are open at the periphery of the template body, but it is within the purview of the present invention that the channels be closed at the outer ends thereof.

A central opening defined by the template body is preferably provided for electrical wiring or the like to extend through the template after installation. In the preferred form, the center opening is spaced inwardly of the plurality of channels defined by the template body. However, the bolt-receiving channels may open into the central opening, if desired.

In the preferred embodiment, bolt-positioning indicia are provided on the upper surface of the template body along at least one of the side edges of each of the bolt-receiving channels. By this configuration, a plurality of associated anchoring bolts can be positioned to respectively extend generally through the channels of the template body, and are preferably secured to the template body by the provision of suitable nuts threaded to the anchor bolts. By this arrangement, simultaneous positioning of the plurality of anchor bolts, and the template, as an assembly or unit, is permitted for anchoring in an associated anchoring material, such as concrete.

In the preferred form, the template body defines a plurality of openings respectively positioned between each adjacent pair of the bolt-receiving channels. The openings permit the introduction of anchoring material, such as concrete, through the template after positioning of the plurality of anchor bolts. The template body further preferably includes a plurality of securement openings in close proximity to the periphery thereof. The securement openings permit securement elements, such as suitable zip ties, or like tying devices, to extend through the securement openings for securing the template body and associated anchor bolts in position for subsequent introduction of the anchoring material.

In one illustrated embodiment of the present invention, the template body is generally circular, and defines the bolt-receiving channels at 90° spacing about the template body. In an alternative embodiment, the template body is generally cross-shaped, and again defines the bolt-receiving channels at 90° spacing. Other shapes, and other spacing of the bolt-receiving channels, are within the purview of the present invention.

In the preferred practice of the present invention, a cylindrical tube is provided upon which the template body is positionable for simultaneous positioning of the plurality of anchor bolts, to thereby permit introduction of the anchoring material into the cylindrical tube. The cylindrical tube also preferably defines a plurality of securement openings to permit associated securement elements, such as zip ties or the like, to extend through the securement openings in the template body and in the cylindrical tube to secure the template body and the anchoring bolts in position generally on top of the cylindrical tube.

In accordance with the present invention, a method of anchoring a vertical structure comprises the steps of providing an anchor bolt template as described above, and providing a cylindrical tube for containing and confining an associated anchoring material, such as concrete. The present method further contemplates that a plurality of anchor bolts are provided, with the anchor bolts positioned on the template body to respectively extend generally vertically through the plurality of bolt-receiving channels defined by the template body.

Simultaneous positioning of the template and plurality of anchor bolts, as an assembly, generally on top of the cylindrical tube is thereafter effected, whereby associated anchoring material, such as concrete, can be subsequently introduced through the template and into the cylindrical tube to thereby anchor the plurality of anchor bolts for subsequent attachment of the vertical structure thereto. Providing bolt-positioning indicia on the upper surface of the template body adjacent each of the bolt-receiving channels facilitates positioning of the anchor bolts, with openings defined by the template body between adjacent ones of the bolt-receiving channels facilitating the introduction of anchoring material into the cylindrical tube through the template. After the anchoring material has suitably hardened or cured, the nuts securing the anchor bolts to the template can be removed, thereby permitting removal and reuse of the template.

Other features and advantages of the present invention will become readily apparent from the following detailed description, the accompanying drawings, and the appended claims.

### BRIEF DESCRIPTION OF THE DRAWINGS

FIG. 1 is a top, plan view of an anchor bolt template embodying the principles of the present invention;

FIG. 2 is a diagrammatic perspective view illustrating use of the anchor bolt template of the present invention;

FIG. 3 is an exploded, diagrammatic perspective view further illustrating use of the anchor bolt template of the present invention; and

FIG. 4 is a top, plan view of an alternate embodiment of the present anchor bolt template.

### DETAILED DESCRIPTION OF THE PREFERRED EMBODIMENT

While the present invention is susceptible of embodiment in various forms, there is shown in the drawings, and will hereinafter be described, presently preferred embodiments, with the understanding that the present disclosure is to be considered as an exemplification of the invention, and is not intended to limit the invention to the specific embodiment illustrated.

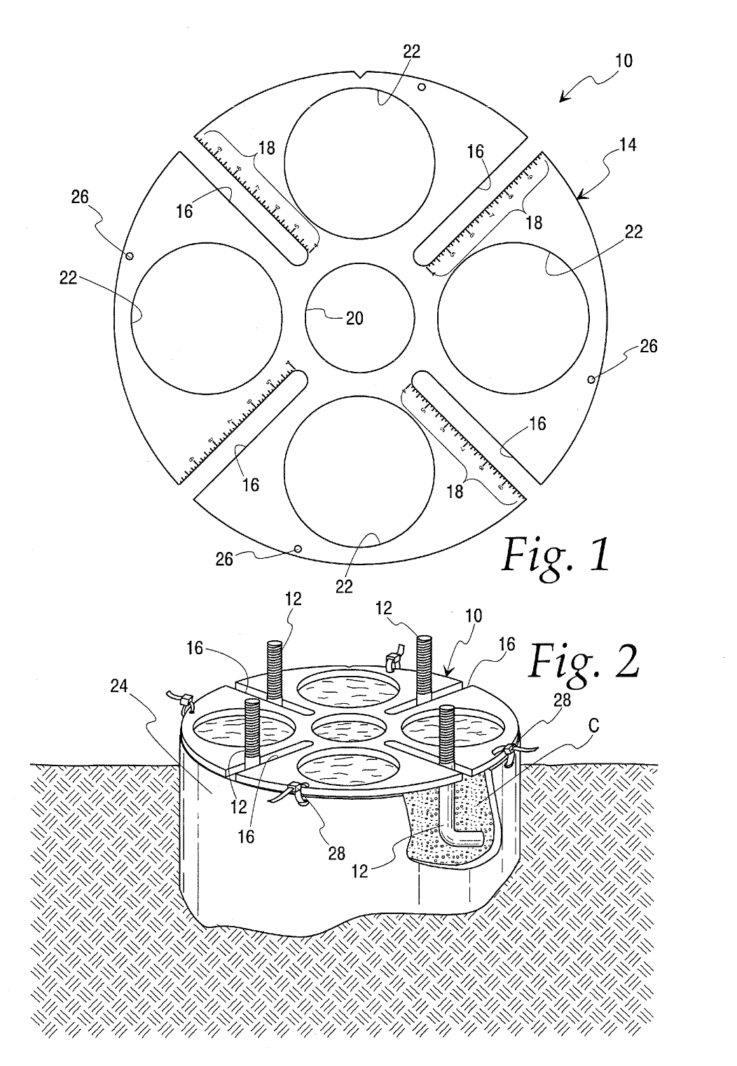

With reference now to FIGS. 1-3, therein is illustrated an anchor bolt template 10 embodying the principles of the present invention. As will be further described, anchor bolt template 10 facilitates efficient, simultaneous positioning of a plurality of associated anchor bolts 12 in associated anchoring material, such as concrete. The anchoring structure thus formed facilitates secure and stable anchoring of an associated vertical structure, such as a lamp post or the like, or other anchored structure.

In accordance with the illustrated embodiment, the anchor bolt template 10 includes a generally planar template body 14 having upper and lower surfaces. In this illustrated embodiment, the template body 14 has a generally circular configuration, but it will be appreciated that the specific configuration of the template body can be varied while keeping with the principles disclosed herein. As will be further described, an alternate embodiment of the present invention comprises a generally cross-shaped template body.

In order to facilitate precise and accurate positioning of the anchor bolts 12 in association with the anchoring material such as concrete C, the template body 14 defines a plurality of circumferentially spaced, bolt-receiving channels 16 extending radially inwardly of the periphery of the template body 14. Each of the bolt-receiving channels has generally parallel side edges, with the bolt-receiving channels 16 preferably being of substantially equal length. Channels 16 can be open at the periphery of template body 14, as illustrated, to facilitate anchor bolt insertion, or may be closed at the periphery of the template body.

By the provision of the bolt-receiving channels, with four such channels 16 provided at 90° spacing in the illustrated embodiment, the plurality of anchor bolts 12 can be respectively vertically positioned within the bolt-receiving channels whereby the anchor bolts 12 and template 10 can be positioned, as an assembly, in association with the anchoring material such as concrete C. To this end, it is contemplated that each anchor bolt 12 be held in position on the template 10 by one or more nuts threaded onto each of the anchor bolts.

Precise and efficient positioning of each anchor bolts 12 in the respective one of the bolt-receiving channels 16 is facilitated by the preferred provision of bolt-positioning indicia 18 which is provided on the upper surface of template body 14 along at least one of the side edges of each of the bolt-receiving channels 16. The bolt-positioning indicia can be provided to facilitate positioning of the anchor bolts 12, and can be provided in any desired increments, such as ¼ inch, ½ inch, etc.

In accordance with the illustrated embodiment, the template body 14 preferably defines a center opening 20 for an associated feed pipe and wiring which is typically provided for an associated lighting structure. As illustrated, the center opening 20 is preferably spaced inwardly of a plurality of bolt-receiving channels 16, but the channels 16 may open into the center opening 20.

Because it is contemplated that the template 10 and the anchor bolts 12 be positioned as a unit for subsequent introduction of the concrete C or other anchoring material, the template body 14 preferably defines a plurality of openings 22 respectively positioned between each adjacent pair of the bolt receiving openings 16. The openings 22 permit the introduction of the anchoring material through the template after positioning of the plurality of anchor bolts.

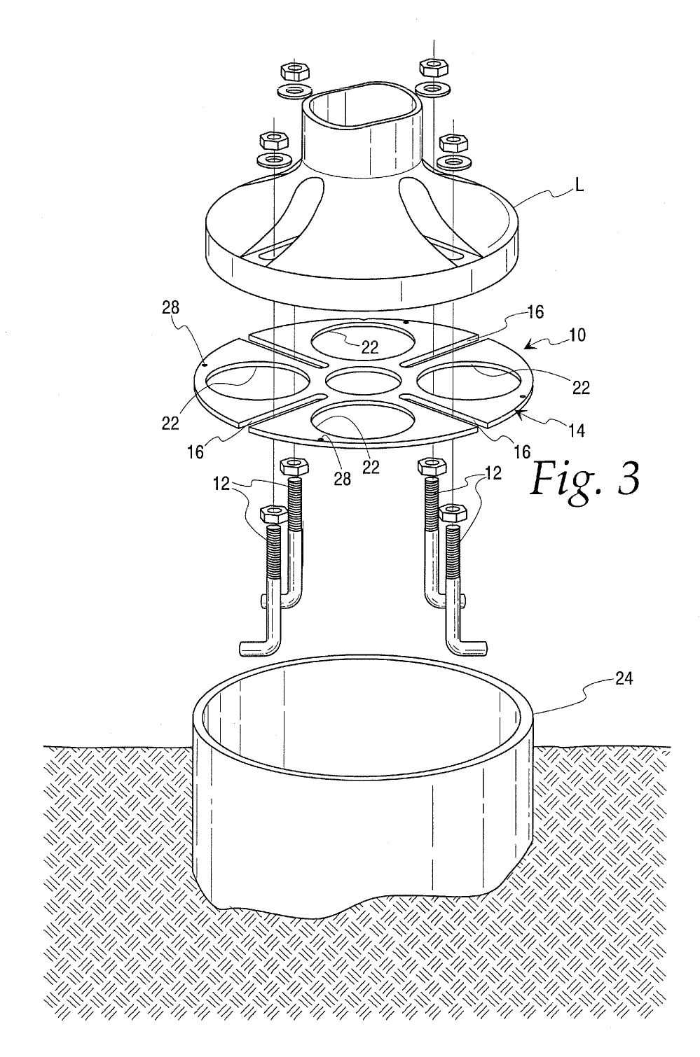

The present invention contemplates that the anchor bolt template 10 is used in operative association with a cylindrical body 24, sometimes referred to as a sonotube, which contains and confines the concrete or other anchoring material. To this end, the template body 14 preferably defines a plurality of securement openings 26 positioned in close proximity to the periphery of the template body. The provision of the securement openings 26 permits associated securement elements, such as zip ties 28 (FIG. 2) to extend through the securement openings in the template body, and through suitable securement openings in the cylindrical tube 24, whereby the anchor bolt template and anchor bolts can be mounted, as an assembly or unit, generally on top of the cylindrical tube 24.

From the foregoing, a method of anchoring a vertical structure, such as light post L (FIG. 3) will be readily appreciated. An anchor bolt template 10 embodying the principle of the present invention is provided, and a cylindrical tube 24 is provided for containing and confining the anchoring material, such as concrete C, with the diameter of the template, such as 18 inches, 30 inches, etc., being greater than the diameter of the cylindrical tube 24, so that the template can be supported on the tube.

A plurality of anchor bolts 12 are provided, and the anchor bolts positioned on the template body 14 of the template 10 so that the anchor bolts respectively extend generally vertically through the plurality bolt-receiving channels 16 defined by the template body 14 of the template 10. The provision of the preferred provision of bolt-positioning indicia 18 facilitates acute positioning of the anchor bolt on the template at the desired spacing for the associated vertical structure. Suitable nuts threaded to the anchor bolts permit the bolts to be secured to the template.

The anchor bolt template 10 and anchor bolts 12 are simultaneous positioned, as an assembly, generally on top of the cylindrical tube 14 for introduction of the anchoring materials such as concrete C through the template. In this way, the plurality of anchor bolts are anchored in the concrete for subsequent attachment of the vertical structure thereto. The provision of securement openings in the body of the template, and in the cylindrical tube 24, facilitate the use of securement elements such as zip ties 28 to securely and stably hold the assembly of the template and anchor bolt in position for subsequent introduction of the anchoring material. After the anchoring material has set or hardened, the nuts securing the anchor bolts 12 to the template 10 can be removed, and the template conveniently removed and reused.

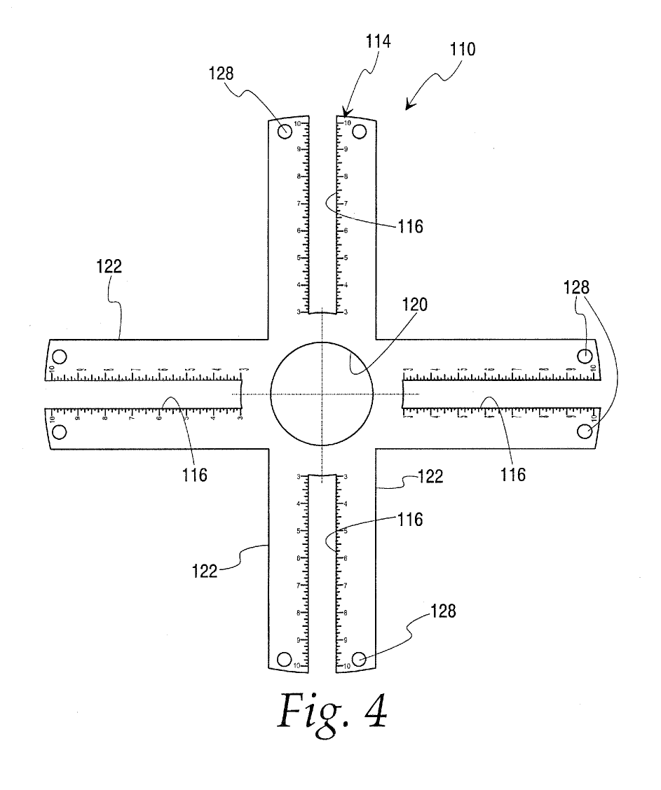

An alternative embodiment of the present invention is illustrated in FIG. 4, which illustrates and anchor bolt template 110 embodying the principles of the present invention. While the previously described anchor bolt template included a generally circular template body, this embodiment of the present invention has a generally cross-shaped template body 114.

As in the previous embodiment, the template body 114 defines a plurality of circumferentially spaced, bolt-receiving channels 116 which extend radially inwardly of the periphery of the template body, with the bolt-receiving channels provided at 90° spacing. Bolt-positioning indicia 118 preferably provided on the upper surface of the template body along at least one of the side edges of the bolt-receiving channels 118. A center opening 120 permits the typical feed tube and wiring to extend through the template when it is in position supporting the anchor bolts. Openings 122 between adjacent pairs of the bolt-receiving channels 116 permit the introduction of anchoring material through the template after it is positioned with the associated anchor bolts. Securement openings 128 facilitate securement of the template 110 on top of an associated cylindrical tube for simultaneously positioning the template and associated anchor bolts in position for introduction of the associated anchoring material.

From the foregoing, it will be observed that many variations of the present invention can be made while keeping with the principals disclosed herein. While the illustrated embodiments include template bodies having circular and cross-shaped configurations, it will be appreciated that the template body can be otherwise shaped or configured. While the bold-receiving openings are shown as being open at the periphery of the template body, it is within the purview of the present invention that the bolt-receiving channels be provided in the form of closed-ended slots which extend radially inwardly of the periphery of the template body.

The bolt-receiving channels of the template body can be appropriate sized for any desired diameter of anchor bolts, and in this regard, it is presently contemplated that the anchor bolt template be color-coded, in accordance with the diameter of the anchor bolts. While it is presently contemplated that templates be provided with either 18 inch or 30 inch outside diameters, or comparable dimensions, the specific dimension of the present template can be varied, depending upon the specific application.

As will be appreciated, the present invention permits efficient installation of anchor bolts at any bolt circle pattern, from the smallest through the largest dimensions, as may be required from the specific application. The bolt-receiving channels of the template can be readily configured to accommodate any desired bolt diameter, with the bolt-positioning indicia preferably provided to accommodate positioning of the anchor bolts in typical patterns. The provision of open-ended bolt-receiving channels permits fast and accurate placement of the anchor bolt without removing the associated nuts and washers typically provided on the bolts, and which facilitate their secure in positioning on the template.

For some applications, it may be desirable to assemble the anchor bolt template and associated anchor bolts, and position them simultaneously, as an assembly, in previously-poured concrete or other anchoring material. For other applications that can be desirable to position the template and anchoring bolts on top of the associated cylindrical tube, and thereafter introduce the anchoring material through the openings in the template.

While the anchor bolt template can be formed from various materials, it is presently contemplated that the template can be formed from suitable polymeric materials, such as high density polyethylene. The template can be made sufficiently durable as to permit its efficient reuse, with the template being easily removable from the anchor bolts, after the associated anchoring material has sufficiently set.

From the foregoing, it will be observed that numerous modifications and variations can be effected without departing from the true spirit and scope of the novel concept of the present invention. It is to be understood that no limitation with respect to the specific embodiments illustrated herein is intended or should be inferred. Disclosure is intended to cover, by the appended claims, all such modifications as fall within the scope of the claims.

What is claimed is:

1. An anchor bolt template, comprising:
a template body having a generally planar configuration, defining upper and lower surfaces,
said template body defining a plurality of circumferentially spaced bolt-receiving channels extending radially inwardly of the periphery of said template body, each of said bolt-receiving channels having generally parallel side edges, with said bolt-receiving channels being of substantially equal length,
a center opening defined by said template body, inwardly of said plurality of bolt-receiving channels, and
bolt-positioning indicia provided on said upper surface of said template body along at least one of said side edges of each of said bolt-receiving channels, whereby a plurality of associated anchoring bolts can be respectively positioned to extend generally vertically through said plurality of bolt-receiving channels, to thereby permit simultaneous positioning of said plurality of anchor bolts for subsequent anchoring in an associated anchoring material.

2. An anchor bolt template in accordance with claim 1, wherein
said template body defines a plurality of openings respectively positioned between each adjacent pair of said bolt-receiving channels, said openings permitting the introduction of said anchoring material through said template after positioning of said plurality anchor bolts.

3. An anchor bolt template in accordance with claim 1, wherein
said template body defines a plurality of securement openings in close proximity to the periphery thereof to permit associated securement elements of extend through the securement openings for securing said template body and said associated anchor bolts in position for subsequent introduction of said anchoring material.

4. An anchor bolt template in accordance with claim 1, wherein
said template body in generally circular, and defines said bolt-receiving channels at 90 degree spacing about the template body.

5. An anchor bolt template in accordance with claim 1, wherein
said template body in generally cross-shaped, and defines said bolt-receiving channels at 90 degree spacing.

6. An anchor bolt template in accordance with claim 1, wherein
Each of said bolt-receiving channels is open at the periphery of said template body.

7. An anchor bolt template in accordance with claim 1, including
a cylindrical tube upon which said template body is positionable for simultaneous positioning of said plurality of anchor bolts to permit introduction of said anchoring material into said cylindrical tube.

8. An anchor bolt template in accordance with claim 7, wherein
each of said template body and said cylindrical tube define a plurality of securement openings to permit associated securement elements to extend through the securement openings in said template body and in said cylindrical tube to secure said template body and said anchoring bolts in position generally on top of said cylindrical tube.

9. A method of anchoring a vertical structure, comprising the steps of:
providing a anchor bolt template comprising a template body having a generally planar configuration and defining upper and lower surfaces, said template body defining a plurality of circumferentially spaced bolt-receiving channels extending radially inwardly of the periphery of said template body, each of said bolt-receiving channels having generally parallel side edges, with said bolt-receiving channels being of substantially equal length, said template body further defining a center opening spaced inwardly of said plurality of bolt-receiving channels,
providing a cylindrical tube;
providing a plurality of anchor bolts, and positioning said anchor bolts on said template body to respectively extend generally vertically through said plurality of bolt-receiving channels; and
simultaneous positioning said template and plurality of anchor bolts, as an assembly, generally on top of said cylindrical tube for subsequent introduction of an associated anchoring material through said template to thereby anchor said plurality of anchor bolts for subsequent attachment of said vertical structure thereto.

10. A method of anchoring a vertical structure in accordance with claim 9, including
providing bolt-positioning indicia on an upper surface of said template body adjacent each of said bolt-receiving channels to facilitate positioning of said anchor bolts on said template body.

11. A method of anchoring a vertical structure in accordance with claim 9, wherein
said template body defines a plurality of openings respectively positioned between adjacent ones of said bolt-receiving channels to facilitate the introduction of said anchoring material through said template.

12. A method of anchoring a vertical structure in accordance with claim 9, including
color-coding said anchor bolt template in accordance with the diameter of said anchor bolts.

13. A method of anchoring vertical structure in accordance with claim 8, including
removing said anchor bolt template after said anchoring material secures said anchor bolts.
